(19) United States
(12) Patent Application Publication
(10) Pub. No.: US 2023/0105183 A1
(43) Pub. Date: Apr. 6, 2023

(54) COMBINED REFORMING APPARATUS

(71) Applicant: DOOSAN ENERBILITY CO., LTD., Changwon (KR)

(72) Inventors: Gyeong Mo Nam, Yongin (KR); Bong Keun Kim, Yongin (KR)

(21) Appl. No.: 17/548,586

(22) Filed: Dec. 12, 2021

(30) Foreign Application Priority Data
Oct. 6, 2021 (KR) 10-2021-0132415

(51) Int. Cl. C01B 3/38; B01J 8/06; B01J 19/18

(52) U.S. Cl. CPC C01B 3/384; C01B 3/382; B01J 8/062; B01J 8/065; B01J 19/1825; C01B 2203/0233; C01B 2203/0244; C01B 2203/1017; C01B 2203/1247; B01J 2208/00893; B01J 2208/00938; B01J 2208/025; B01J 2208/065; C01B 2203/0816; B01J 2208/00504; C01B 2203/0238; B01J 2208/021

(57) ABSTRACT

A combined reforming apparatus is provided. The combined reforming apparatus includes a body, a plurality of first catalyst tubes disposed inside the body and reacting at a first temperature to reform hydrocarbons (CₓH_{y}) having two or more carbon atoms into methane (CH₄), a plurality of second catalyst tubes disposed inside the body, connected to the plurality of first catalyst tubes, and reacting at a second temperature higher than the first temperature to reform methane (CH₄) into synthesis gas containing hydrogen (H₂) and carbon monoxide (CO), a combustion unit configured to supply heat to the plurality of first catalyst tubes and the plurality of second catalyst tubes, and a first distributor configured to connect the plurality of first catalyst tubes to each of the second catalyst tubes to distribute steam and gas discharged from the plurality of first catalyst tubes to the plurality of second catalyst tubes.

### CROSS REFERENCE TO RELATED APPLICATION

This application claims priority to Korean Patent Application No. 10-2021-0132415, filed on Oct. 6, 2021, the disclosure of which is incorporated herein by reference in its entirety.

### BACKGROUND

### 1. Field

Apparatuses and methods consistent with exemplary embodiments relate to a combined reforming apparatus, and more particularly, to a combined reforming apparatus including two or more catalyst tubes reacting at different temperatures to reform hydrocarbons (CₓH_{y}) having two or more carbon atoms into methane (CH₄) and reform methane (CH₄) into synthesis gas composed of hydrogen (H₂) and carbon monoxide (CO).

### 2. Description of the Related Art

A related art steam methane reforming apparatus (SMR) is an apparatus for reforming natural gas containing methane (CH₄) as a main component. The related art steam methane reformer has a problem in that the structure and process are complicated because a preliminary reformer for reforming the high carbon-number hydrocarbons into methane is required when reforming a gas containing a hydrocarbon (CxHy) having a high carbon number.

### SUMMARY

Aspects of one or more exemplary embodiments provide a combined reforming apparatus including two or more catalyst tubes reacting at different temperatures, thereby reforming hydrocarbons (CₓH_{y}) having two or more carbon atoms into methane (CH₄) and reforming methane (CH₄) into synthesis gas composed of hydrogen (H₂) and carbon monoxide (CO).

Additional aspects will be apparent in part in the description which follows and, in part, will become apparent from the description from the following description, or may be learned by practice of the exemplary embodiments.

According to an aspect of an exemplary embodiment, there is provided a combined reforming apparatus including: a body; a plurality of first catalyst tubes disposed inside the body and reacting at a first temperature to reform hydrocarbons (CₓH_{y}) having two or more carbon atoms into methane (CH₄); a plurality of second catalyst tubes disposed inside the body, connected to the plurality of first catalyst tubes, and reacting at a second temperature higher than the first temperature to reform methane (CH₄) into synthesis gas containing hydrogen (H₂) and carbon monoxide (CO); a combustion unit configured to supply heat to the plurality of first catalyst tubes and the plurality of second catalyst tubes; and a first distributor configured to connect the plurality of first catalyst tubes to each of the second catalyst tubes to distribute steam and gas discharged from the plurality of first catalyst tubes to the plurality of second catalyst tubes.

Pyrolysis gas generated through pyrolysis of waste and steam may be supplied to the plurality of first catalyst tubes.

Combustion gas discharged from the combustion unit may supply heat to the plurality of second catalyst tubes and then supply heat to the plurality of first catalyst tubes.

The combustion gas may be discharged through a center portion of the body.

The plurality of second catalyst tubes may be disposed more inward than the plurality of first catalyst tubes in a radial direction of the body.

The first distributor may include a first chamber to which an output port of each of the plurality of first catalyst tubes and an input port of each of the plurality of second catalyst tubes are connected.

The first distributor may include a second chamber to which an output port of each of the plurality of second catalyst tubes are connected.

The second chamber may be disposed inside the first chamber in a radial direction of the first chamber.

The plurality of second catalyst tubes may have a U-curved portion.

The second catalyst tube may be connected to a synthesis gas discharge unit through which the synthesis gas is discharged outside.

The plurality of first catalyst tubes and the plurality of second catalyst tubes may be arranged in parallel along a longitudinal direction of the body, and a first wall extending from a portion of the body may be disposed between the plurality of first catalyst tubes and the plurality of second catalyst tubes.

The combined reforming apparatus may further include a second distributor configured to distribute hydrocarbon gas and steam to be supplied to the plurality of first catalyst tubes.

The second distributor may include a third chamber to which one or more supply units through which the steam and the hydrocarbon gas are supplied are connected and to which an input port of each of the plurality of first catalyst tubes are connected.

The combustion unit may be disposed in a center of the second distributor.

The body may include a combustion gas discharge unit through which the combustion gas is discharged outside.

The combined reforming apparatus may further include a plurality of partition walls partially extending in a first inward direction from an inner surface of the first wall and the remainder extending in a second inward direction opposite to the first inward direction from the inner surface of the first wall.

The partition walls extending in the first inward direction and the partition walls extending in the second inward direction may be alternately arranged.

Each of the plurality of first catalyst tubes may be a spiral tube.

Each of the plurality of first catalyst tubes may include a linear input portion connected to the second distributor, a spiral intermediate portion, and a linear output portion connected to the first distributor.

According to an aspect of another exemplary embodiment, there is provided a combined reforming apparatus including: a body; a plurality of first catalyst tubes disposed inside the body and reacting at a first temperature to reform hydrocarbons (CₓH_{y}) having two or more carbon atoms into methane (CH₄); a plurality of second catalyst tubes disposed inside the body, connected to the plurality of first catalyst tubes, and reacting at a second temperature higher than the first temperature to reform methane (CH₄) into synthesis gas containing hydrogen (H₂) and carbon monoxide (CO); a combustion unit configured to supply heat to the plurality of first catalyst tubes and the plurality of second catalyst tubes; and a second distributor configured to distribute hydrocarbon gas and steam supplied to the plurality of first catalyst tubes to plurality of second catalyst tubes.

According to one or more exemplary embodiments, because the combined reforming apparatus includes two or more catalyst tubes reacting at different temperatures, hydrocarbons (CₓH_{y}) having two or more carbon atoms can be reformed into methane (CH₄), and the methane (CH₄) can be reformed into synthesis gas composed of hydrogen (H₂) and carbon monoxide (CO) at the same time. Accordingly, there is no need to additionally install a preliminary reformer, thereby simplifying the structure and process for gas reforming.

Further, one or more exemplary embodiments can be used for reforming pyrolysis gas generated during pyrolysis of wastes in which the pyrolysis gas contains a large amount of hydrocarbon having two or more carbon atoms.

In addition, because a first distributor for distributing the gas and steam discharged from the plurality of first catalyst tubes to the plurality of second catalyst tubes is included, the gas and steam can be uniformly supplied to the plurality of second catalyst tubes.

In addition, because a second distributor for distributing hydrocarbon gas and steam to be supplied to the plurality of first catalyst tubes is included, the hydrocarbon gas and steam can be uniformly supplied to the plurality of first catalyst tubes.

### BRIEF DESCRIPTION OF THE DRAWINGS

The above and other aspects will be more apparent from the following description of the exemplary embodiments with reference to the accompanying drawings, in which:

FIG. 1 is a cross-sectional view illustrating a combined reforming apparatus according to a first exemplary embodiment;

FIG. 2 is a cross-sectional view taken along line A-A′ of FIG. 1;

FIG. 3 is a partial perspective view illustrating a first distributor illustrated in FIG. 1;

FIG. 4 is a partial perspective view illustrating a second distributor illustrated in FIG. 1;

FIG. 5 is a cross-sectional view illustrating a combined reforming apparatus according to a second exemplary embodiment; and

FIG. 6 is a cross-sectional view illustrating a combined reforming apparatus according to a third exemplary embodiment.

### DETAILED DESCRIPTION

Various modifications and various embodiments will be described with reference to the accompanying drawings. However, it should be noted that the various embodiments are not for limiting the scope of the disclosure to the specific embodiment, but they should be interpreted to include all modifications, equivalents, or substitutions of the embodiments included within the spirit and scope disclosed herein.

The terminology used herein is for the purpose of describing specific embodiments only and is not intended to limit the scope of the disclosure. The singular expressions “a”, “an”, and “the” are intended to include the plural expressions as well unless the context clearly indicates otherwise. In the disclosure, terms such as “comprises”, “includes”, or “have/has” should be construed as designating that there are such features, integers, steps, operations, components, parts, and/or combinations thereof, not to exclude the presence or possibility of adding of one or more of other features, integers, steps, operations, components, parts, and/or combinations thereof.

Exemplary embodiments will be described below in detail with reference to the accompanying drawings. It should be noted that like reference numerals refer to like parts throughout the various figures and exemplary embodiments. In certain embodiments, a detailed description of functions and configurations well known in the art may be omitted to avoid obscuring appreciation of the disclosure by a person of ordinary skill in the art. For the same reason, some components may be exaggerated, omitted, or schematically illustrated in the accompanying drawings.

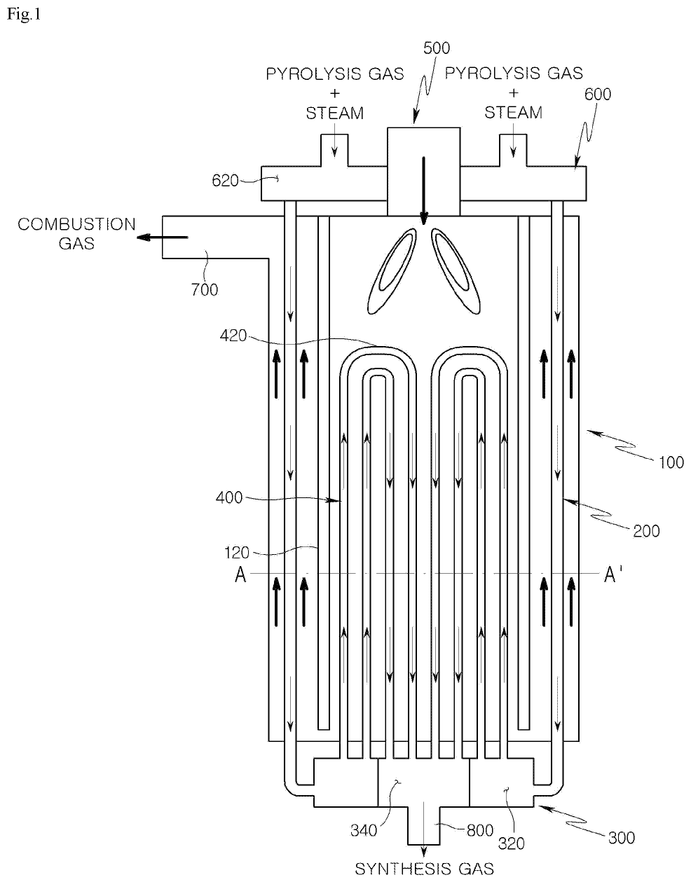

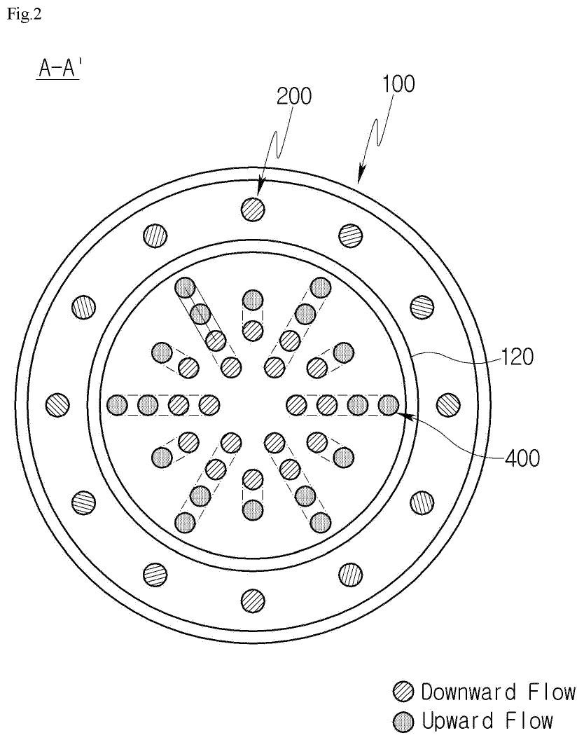

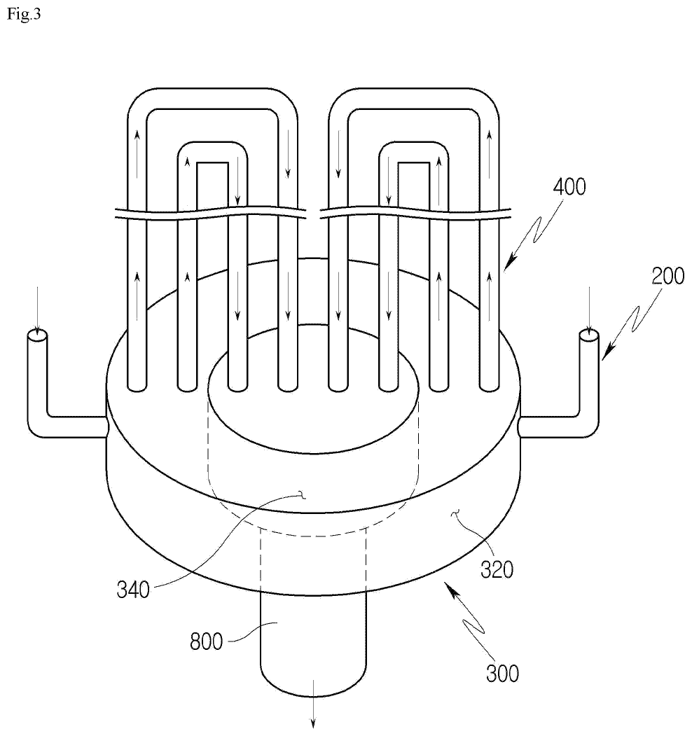

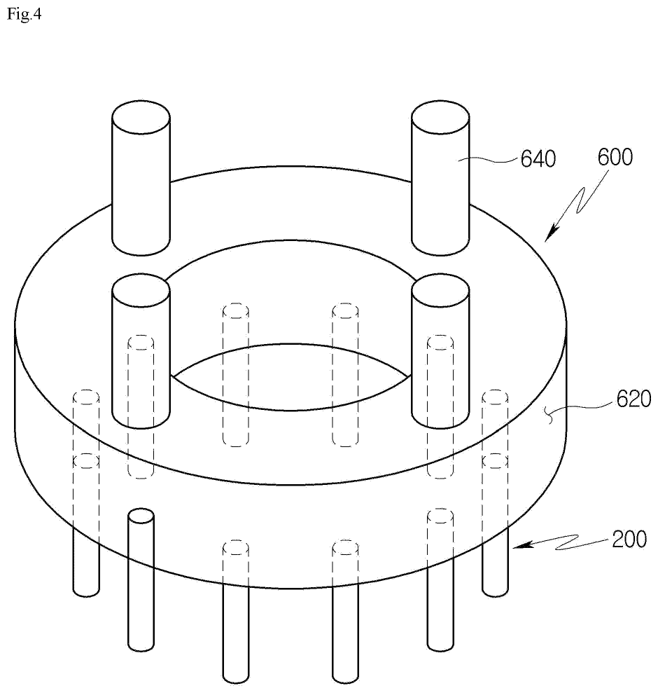

Hereinafter, a combined reforming apparatus according to a first exemplary embodiment will be described with reference to the accompanying drawings. FIG. 1 is a cross-sectional view illustrating a combined reforming apparatus according to a first exemplary embodiment. FIG. 2 is a cross-sectional view taken along line A-A′ of FIG. 1. FIG. 3 is a partial perspective view illustrating a first distributor illustrated in FIG. 1. FIG. 4 is a partial perspective view illustrating a second distributor illustrated in FIG. 1.

Referring to FIG. 1, the combined reforming apparatus includes a body 100, a first catalyst tube 200, a first distributor 300, a second catalyst tube 400, a combustion unit 500, a second distributor 600, a combustion gas discharge unit 700, and a synthesis gas discharge unit 800.

The body 100 is formed in a cylindrical shape having an inner space to define an external shape of the combined reforming apparatus. However, it is understood that the shape of the body 100 is not limited to the cylindrical shape.

Two or more catalyst tubes containing different catalysts reacting at different temperatures are disposed in the body 100. For example, there are a plurality of first catalyst tubes 200 for reforming hydrocarbons (CₓH_{y}) having two or more carbon atoms into methane (CH₄) and a plurality of second catalyst tubes 400 for reforming methane (CH₄) into synthesis gas containing hydrogen (H₂) and carbon monoxide (CO). The first catalyst tube 200 reacts at a first temperature T1, and the second catalyst tube 400 reacts at a second temperature T2 higher than the first temperature T1.

The first temperature T1, which is the reaction temperature of the first catalyst tube 200, may be about 350° C. to 550° C., and a catalyst for reforming hydrocarbons having two or more carbon atoms is used. For example, a nickel-based catalyst using MgO or Al₂O₃ or a combination thereof as a support may be used for the first catalyst tube 200. Therefore, in the first catalyst tube 200, higher hydrocarbons having two or more carbon atoms, such as ethane, propane, and butane, may be converted into methane, carbon monoxide, and hydrogen through reactions represented by Reaction Formulas 1 and 2 below.

CₙHₘ+nH₂O→nCO+(n+m/2)H₂ Reaction Formula 1:

CO+3H₂→CH₄+H₂O Reaction Formula 2:

The second temperature T2, which is the reaction temperature of the second catalyst tube 400, may be about 700° C. to 900° C., and a catalyst for reforming methane is used. For example, a nickel-based catalyst may also be used for the second catalyst tube 400. Therefore, in the second catalyst tube 400, methane may be converted into synthesis gas mainly composed of hydrogen and carbon monoxide through a reaction represented by Reaction Formula 3 below.

CH₄+H₂O→CO+3H₂ Reaction Formula 3:

The plurality of first catalyst tubes 200 and the plurality of second catalyst tube 400 are connected to each other via the first distributor 300, respectively so that hydrocarbon gas and steam supplied to the plurality of first catalyst tubes 200 sequentially flow through the plurality of first catalyst tubes 200, the first distributor 300, and the plurality of second catalyst tubes 400. In this case, the gas and steam discharged from the plurality of first catalyst tubes 200 can be uniformly supplied to the plurality of second catalyst tubes 400 through the first distributor 300.

Accordingly, although the hydrocarbon gas supplied to the first catalyst tube 200 contains a large amount of hydrocarbon having two or more carbon atoms, the pyrolysis gas can be reformed into synthesis gas through steam reforming reactions while sequentially passing through the first catalyst tube 200 and the second catalyst tube 400. That is, higher hydrocarbons having two or more carbon atoms may be converted into methane while passing through the first catalyst tube 200, and the methane may be converted into synthesis gas while passing through the second catalyst tube 400. For example, the hydrocarbon gas supplied to the first catalyst tube 200 may be a pyrolysis gas generated through pyrolysis of wastes. For example, the hydrocarbon gas may be a pyrolysis gas generated by pyrolysis of waste plastics, and the hydrocarbon gas may contain a large amount of hydrocarbon having two or more carbon atoms.

The combustion unit 500 for supplying heat to the plurality of first catalyst tubes 200 and the plurality of second catalyst tubes 400 is installed in an upper center of the body 100. In the combustion unit 500, the hydrocarbon gas is combusted to generate combustion gas. The generated combustion gas is discharged to the outside through the center of the body 100.

Because the second catalyst tube 400 reacts at a higher temperature than the first catalyst tube 200, the combustion gas discharged from the combustion unit 500 first supplies heat to the plurality of second catalyst tubes 400 and then supplies heat to the plurality of first catalyst tubes 200. To this end, the plurality of second catalyst tubes 400 are positioned radially inside the body 100 rather than the plurality of first catalyst tubes 200.

Referring to FIG. 2, the plurality of first catalyst tubes 200 are spaced apart from each other in a circumferential direction of the body 100. In addition, the plurality of second catalyst tubes 400 are disposed to be spaced apart from each other in the circumferential direction of the body 100 and disposed radially inside the body 100 rather than the plurality of first catalyst tubes 200. The number of the plurality of first catalyst tubes 200 and the number of the plurality of second catalyst tubes 400 vary depending on a scale of the reforming apparatus. The plurality of first catalyst tubes 200 and the plurality of second catalyst tubes 400 extend vertically along a longitudinal direction of the body 100.

Here, each of the second catalyst tubes 400 has a U-curved portion 420. For example, each of the plurality of second catalyst tubes 400 extends vertically upward from a lower side of the body 100, then curves in a U shape at an upper end (i.e., the U-curved portion 420), and then extends vertically downward. The number of U-curved portions 420 may vary depending on a catalyst reaction time. As the required catalyst reaction time increases, the number of U-curved portions 420 may increase.

Referring to FIG. 3, the first distributor 300 is connected to an output port of each of the plurality of first catalyst tubes 200, an input port of each of the plurality of second catalyst tubes 400, and an output port of each of the plurality of second catalyst tubes 400. For example, the first distributor 300 includes a first chamber 320 to which the output port of each of the first catalyst tubes 200 and the input port of each of the second catalyst tubes 400 are connected. Gas and steam discharged from the plurality of first catalyst tubes 200 may be collected in the first chamber 320 and uniformly supplied to each of the plurality of second catalyst tubes 400.

The first distributor 300 includes a second chamber 340 to which the output port of each of the second catalyst tubes 400 are connected. The second chamber 340 serves to collect the synthesis gas discharged from the plurality of second catalyst tubes 400, and the collected synthesis gas is discharged to the outside through the synthesis gas discharge unit 800 connected to the second chamber 340.

In this case, because the second catalyst tube 400 has a U-curved portion 420, the second chamber 340 may be disposed inside the first chamber 320 in the radial direction. With this arrangement, the first distributor 300 has a compact size, but the gas and steam discharged from the plurality of first catalyst tubes 200 may be uniformly supplied to the plurality of second catalyst tubes 400 to discharge the synthesis gas at once.

Referring to FIGS. 1 and 2, a first wall 120 is provided in the body 100. The first wall 120 serve to guide the flow of the combustion gas discharged from the combustion unit 500 to effectively supply heat to the first catalyst tubes 200 and the second catalyst tubes 400. The first wall 120 is provided between the plurality of first catalyst tubes 200 and the plurality of second catalyst tubes 400, and extends vertically downward from the upper side of the body 100. Accordingly, the combustion gas discharged from the combustion unit 500 flows in a zigzag direction along the longitudinal direction of the plurality of first catalyst tube 200 and the plurality of second catalyst tube 400, thereby supplying sufficient heat to the first and second catalyst tubes 200 and 400 and generating a temperature gradient in the first and second catalyst tubes 200 and 400.

Accordingly, as illustrated in FIG. 1, the combustion gas discharged from the combustion unit 500 supplies heat to the second catalyst tubes 400 while flowing downward, and the combustion gas whose temperature is slightly lowered thereafter passes through a space under the first wall 120. Then, the combustion gas flows upward to supply heat to the first catalyst tubes 200. After supplying heat to the plurality of first catalyst tubes 200 and the plurality of second catalyst tubes 400, the combustion gas is discharged to the outside by the combustion gas discharge unit 700 included in the body 100.

The combined reforming apparatus further includes a second distributor 600 for distributing the hydrocarbon gas and steam to be supplied to the plurality of first catalyst tubes 200.

Referring to FIG. 4, the second distributor 600 includes one or more supply units 640 to which hydrocarbon gas and steam are supplied and a third chamber 620 to which the input port of each of the first catalyst tubes 200 is connected. The gas and steam discharged from the one or more supply units 640 may be collected in the third chamber 620 and uniformly supplied to each of the plurality of first catalyst tubes 200. In this case, the combustion unit 500 may be installed in the center of the second distributor 600.

Although the combined reforming apparatus according to the first exemplary embodiment includes both the first distributor 300 and the second distributor 600, it is understood that the combined reforming apparatus according to another exemplary embodiment may include only the first distributor 300 or only the second distributor 600.

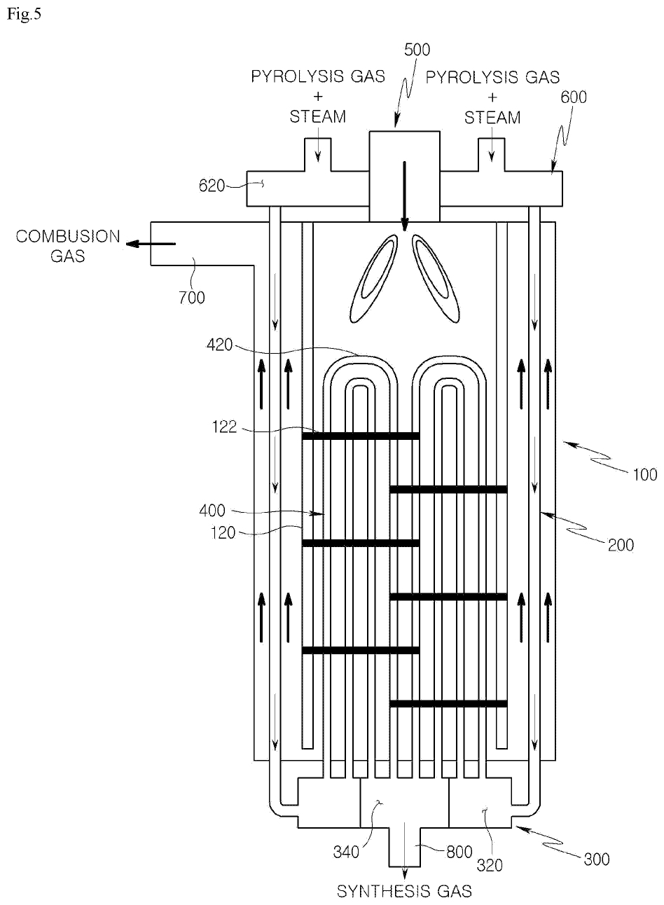

FIG. 5 is a cross-sectional view illustrating a combined reforming apparatus according to a second exemplary embodiment.

The combined reforming apparatus according to the second exemplary embodiment has the same structure as the combined reforming apparatus according to the first exemplary embodiment except for a plurality of partition walls 122 extending inward from an inner surface of the first wall 120, a redundant description of the same configuration will be omitted. Referring to FIG. 5, some of the partition walls 122 extend in a first inward direction from an inner surface of the first wall 120 and the other partition walls 122 extend in a second inward direction from the inner surface of the first wall 120. The first inward direction and the second inward direction are opposite directions.

That is, the plurality of partition walls 122 extend horizontally from both sides of the first wall 120. The partition walls 122 extending in the first inward direction and the partition walls 122 extending in the second inward direction are alternately arranged. This arrangement of the partition walls makes the combustion gas meanders while flowing in the radial direction of the body 100. That is, the arrangement increases a moving path of the combustion gas to increase the contact time of the combustion gas with the plurality of second catalyst tubes 400, thereby supplying sufficient heat to the plurality of second catalyst tubes 400.

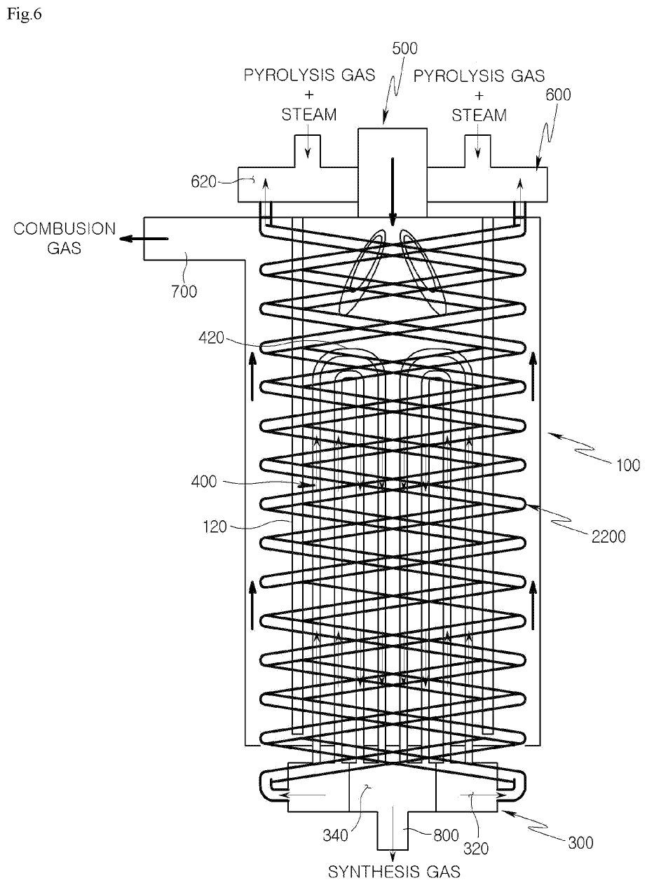

FIG. 6 is a cross-sectional view illustrating a combined reforming apparatus according to a third exemplary embodiment.

The combined reforming apparatus according to the third exemplary embodiment has the same structure as the combined reforming apparatus according to the first exemplary embodiment except for a shape of a first catalyst tube 2200, a redundant description of the same configuration will be omitted.

Referring to FIG. 6, each of a plurality of first catalyst tubes 2200 is a spiral tube. For example, the first catalyst tube 2200 may include a linear input portion connected to the second distributor 600, a spiral intermediate portion, and a linear output portion connected to the first distributor 300. Accordingly, compared to the first exemplary embodiment in which the first catalyst tube 200 is formed in a linear shape, a length of the first catalyst tube 2200 of the third exemplary embodiment is increased because the first catalyst tube 2200 has a spiral shape. The first catalyst tube 2200 in the form of a spiral tube increases the reaction time of the gas. The total length of the spiral intermediate portion of the first catalyst tube 2200 may vary depending on the required reaction time of the gas in catalyst.

According to one or more exemplary embodiments, because the combined reforming apparatus includes two or more catalyst tubes reacting at different temperatures, hydrocarbons (CₓH_{y}) having two or more carbon atoms can be reformed into methane (CH₄), and the methane (CH₄) can be reformed into synthesis gas composed of hydrogen (H₂) and carbon monoxide (CO) at the same time. Accordingly, there is no need to additionally install a preliminary reformer, thereby simplifying the structure and process for gas reforming.

In addition, one or more exemplary embodiments can be used for reforming pyrolysis gas generated during pyrolysis of wastes in which the pyrolysis gas contains a large amount of hydrocarbon having two or more carbon atoms.

While exemplary embodiments have been described with reference to the accompanying drawings, it is to be understood by those skilled in the art that various modifications in form and details may be made therein without departing from the sprit and scope as defined by the appended claims. Therefore, the description of the exemplary embodiments should be construed in a descriptive sense and not to limit the scope of the claims, and many alternatives, modifications, and variations will be apparent to those skilled in the art.

What is claimed is:

1. A combined reforming apparatus comprising:
a body;
a plurality of first catalyst tubes disposed inside the body and reacting at a first temperature to reform hydrocarbons (CₓH_{y}) having two or more carbon atoms into methane (CH₄);
a plurality of second catalyst tubes disposed inside the body, connected to the plurality of first catalyst tubes, and reacting at a second temperature higher than the first temperature to reform methane (CH₄) into synthesis gas containing hydrogen (H₂) and carbon monoxide (CO);
a combustion unit configured to supply heat to the plurality of first catalyst tubes and the plurality of second catalyst tubes; and
a first distributor configured to connect the plurality of first catalyst tubes to each of the second catalyst tubes to distribute steam and gas discharged from the plurality of first catalyst tubes to the plurality of second catalyst tubes.

2. The combined reforming apparatus according to claim 1, wherein pyrolysis gas generated through pyrolysis of waste and steam are supplied to the plurality of first catalyst tubes.

3. The combined reforming apparatus according to claim 1, wherein combustion gas discharged from the combustion unit supplies heat to the plurality of second catalyst tubes and then supplies heat to the plurality of first catalyst tubes.

4. The combined reforming apparatus according to claim 3, wherein the combustion gas is discharged through a center portion of the body.

5. The combined reforming apparatus according to claim 4, wherein the plurality of second catalyst tubes are disposed more inward than the plurality of first catalyst tubes in a radial direction of the body.

6. The combined reforming apparatus according to claim 5, wherein the first distributor comprises a first chamber to which an output port of each of the plurality of first catalyst tubes and an input port of each of the plurality of second catalyst tubes are connected.

7. The combined reforming apparatus according to claim 6, wherein the first distributor comprises a second chamber to which an output port of each of the plurality of second catalyst tubes are connected.

8. The combined reforming apparatus according to claim 7, wherein the second chamber is disposed inside the first chamber in a radial direction of the first chamber.

9. The combined reforming apparatus according to claim 8, wherein the plurality of second catalyst tubes have a U-curved portion.

10. The combined reforming apparatus according to claim 7, wherein the second catalyst tube is connected to a synthesis gas discharge unit through which the synthesis gas is discharged outside.

11. The combined reforming apparatus according to claim 3, wherein the plurality of first catalyst tubes and the plurality of second catalyst tubes are arranged in parallel along a longitudinal direction of the body, and
a first wall extending from a portion of the body is disposed between the plurality of first catalyst tubes and the plurality of second catalyst tubes.

12. The combined reforming apparatus according to claim 1, further comprising a second distributor configured to distribute hydrocarbon gas and steam to be supplied to the plurality of first catalyst tubes.

13. The combined reforming apparatus according to claim 12, wherein the second distributor comprises a third chamber to which one or more supply units through which the steam and the hydrocarbon gas are supplied are connected and to which an input port of each of the plurality of first catalyst tubes are connected.

14. The combined reforming apparatus according to claim 12, wherein the combustion unit is disposed in a center of the second distributor.

15. The combined reforming apparatus according to claim 3, wherein the body includes a combustion gas discharge unit through which the combustion gas is discharged outside.

16. The combined reforming apparatus according to claim 11, further comprising a plurality of partition walls partially extending in a first inward direction from an inner surface of the first wall and the remainder extending in a second inward direction opposite to the first inward direction from the inner surface of the first wall.

17. The combined reforming apparatus according to claim 16, wherein the partition walls extending in the first inward direction and the partition walls extending in the second inward direction are alternately arranged.

18. The combined reforming apparatus according to claim 12, wherein each of the plurality of first catalyst tubes are a spiral tube.

19. The combined reforming apparatus according to claim 18, wherein each of the plurality of first catalyst tubes includes a linear input portion connected to the second distributor, a spiral intermediate portion, and a linear output portion connected to the first distributor.

20. A combined reforming apparatus comprising:
a body;
a plurality of first catalyst tubes disposed inside the body and reacting at a first temperature to reform hydrocarbons (CₓH_{y}) having two or more carbon atoms into methane (CH₄);
a plurality of second catalyst tubes disposed inside the body, connected to the plurality of first catalyst tubes, and reacting at a second temperature higher than the first temperature to reform methane (CH₄) into synthesis gas containing hydrogen (H₂) and carbon monoxide (CO);
a combustion unit configured to supply heat to the plurality of first catalyst tubes and the plurality of second catalyst tubes; and
a second distributor configured to distribute hydrocarbon gas and steam supplied to the plurality of first catalyst tubes to plurality of second catalyst tubes.
